(19) United States
(12) Patent Application Publication
(10) Pub. No.: US 2014/0303999 A1
(43) Pub. Date: Oct. 9, 2014

(54) METHOD FOR CREATING AND USING REGISTRY OF CLINICAL TRIAL PARTICIPANTS

(71) Applicant: Mitchell D. Efros, Roslyn, NY (US)

(72) Inventor: Mitchell D. Efros, Roslyn, NY (US)

(21) Appl. No.: 14/356,669

(22) PCT Filed: Nov. 7, 2012
(86) PCT No.: PCT/US12/63806

§ 371 Date: May 7, 2014

Related U.S. Application Data
(60) Provisional application No. 61/556,533, filed on Nov. 7, 2011.

(51) Int. Cl. G06F 19/00

(52) U.S. Cl. CPC G06F 19/363
USPC 705/2

(57) ABSTRACT

A method of screening participants for a clinical trial by obtaining a biometric sample from a prospective participant, generating a unique identifier code, populating a database with the unique identifier code and participant information and storing the database on computer readable media, and screening the participant for the clinical trial based on the unique identifier code and participant information. A method of screening participants for a clinical trial by obtaining personal information from a prospective participant, generating a unique identifier code, populating a database with the unique identifier code and participant information and storing the database on computer readable media, and screening the participant for the clinical trial based on the unique identifier code and participant information. A database stored on computer readable media populated by unique identifier codes of prospective participants of clinical trials obtained by the methods.

### BACKGROUND OF THE INVENTION

1. Technical Field

The present invention relates to registries of clinical trial participants. More specifically, the present invention relates to methods of preventing participants from enrolling in multiple clinical trials simultaneously, and to perform other types of checks on participants, across all types of drug and device trials in all phases of clinical research.

2. Background Art

There are many research studies conducted by various institutions and companies that make up “clinical trials”. These clinical trials are generally used to verify the safety and efficacy of pharmaceuticals, biopharmaceuticals, and medical devices for the FDA. There are many different types of clinical trials, including treatment trials, prevention trials, diagnostic trials, screening trials, and quality of life trials.

The general public can enroll in clinical trials if they meet the criteria of the particular trial, such as having or not having a certain medical condition, currently taking a particular type of medicine, or having certain health characteristics. Clinical trials can be beneficial to many people who have exhausted currently approved treatments for their conditions since they allow such people to seek experimental procedures in order to improve their quality of life. People enrolled in clinical trials must also be aware of their risks, such as side effects and adverse reactions, or the fact that the treatment might not provide any results. There is a lot of motivation for people, especially in bad economic times, to join clinical trials because they are compensated monetarily to receive medical evaluation and care as well as free medication. However, some people try to enroll in clinical trials more than once under false information, or in several clinical trials at the same time. This not only can be dangerous to the person's health, but it can result in unreliable data for the organization conducting the trial.

There are several methods currently used for maintaining registries for clinical trials. For example, U.S. Patent Application Publication No. 2008/0052125 to Bennett, et al. discloses a method for maintaining the contact information of an enrollee in a clinical study while maintaining the anonymity of the enrollee from the clinical study sponsor. The method includes: (1) obtaining contact information for the enrollee in the clinical study; (2) entering the contact information into a database; (3) using a contact cascade on a scheduled, periodic basis to contact the enrollee using the contact information from the database to ensure that the contact information is correct; and (4) updating the contact information if a contact is made with the enrollee and the contact information needs to be updated to be accurate. While this method keeps track of contact information, it cannot easily be used to prevent multiple enrollments under false information.

U.S. Patent Application Publication No. 2008/0033658 to Dalton, et al. discloses computers, computer program products, and methods for identifying a plurality of subjects for a clinical trial. A candidate set of molecular profiles in a stored plurality of molecular profiles are identified. Each such profile has measurements for a discriminating set of cellular constituents that match the measurements of corresponding cellular constituents in a responder set of biological samples, thereby identifying the plurality of subjects for the trial from those subjects from which the candidate set of molecular profiles were derived. Each respective molecular profile in the stored plurality of profiles has measurements of a plurality of cellular constituents from a respective biological sample in a plurality of samples obtained from a first plurality of subjects. The discriminating set of cellular constituents is identified from those cellular constituents in the plurality of cellular constituents whose measurement values discriminates between the responder and nonresponder sets of biological samples. This method is used to select specific candidates for a particular trial based on their biological samples, but is not used to prevent multiple enrollments.

U.S. Patent Application Publication No. 2010/0023870 to Baker discloses an apparatus and methods that implement a computer-based system and procedure for the efficient and effective operation of one or more clinical trials using an institutional review board (IRB). The various methods are deployed against the backdrop of an Internet-based Software As A Service (SaaS) platform, allowing access to the system by all relevant participants. Each authorized participant in the clinical trial can have a customized and customizable view of the clinical trial and interact with the other participants electronically. The various documents required for completion of the clinical trial or study, as well as the various compliance documents needed to satisfy regulatory agencies are all available for review via the Internet. By utilizing the methods and system of the present invention, greater protection is offered for the human subjects of the clinical trials. Further, the sponsors, investigators, and the study participants can experience increased productivity. Finally, FDA mandated information can be more readily tracked and, accordingly, compliance with FDA guidelines can be enhanced. This method is directed to controlling information pertaining to the trials, but does not prevent multiple enrollments.

U.S. Patent Application Publication Nos. 2005/0159654 and 2003/0130871 to Rao, et al. disclose a system and method for selecting prospective patients for a clinical trial. In various embodiments, a clinical trials brokerage is configured to receive requests from drug companies for lists of persons meeting specified criteria for clinical trials. Patient records are retrieved from a structured computerized patient record (CPR) data warehouse populated with comprehensive patient information mined from unstructured hospital records. A list of persons for whom consent was obtained can be outputted and forwarded to the entity interested in performing the clinical trial and which requested the list. Anonymity of a patient can be maintained until the patient provides consent to participate in the clinical trial. This method also does not provide any secure means of preventing multiple enrollments in trials.

Clinical RSVP is a web-based subject registry used by investigators to make better-informed enrollment decisions for clinical research studies. Research sites can report dose dates of subjects for the purpose of identifying ineligible subjects and ensuring against dual enrollment. Fingerprint biometric identification (or other biometric information, such as iris, retinal, or facial recognition or DNA) can be used along with other identifying information such as initials, birth date, sex, and last four digits of a social security or tax ID number. The subject is fingerprinted when screened for the trial, the fingerprint is then scanned, and a code is generated and stored in a database along with the other identifiers. The registry is searchable for a subject's information. Clinical RSVP is used for phase I trials. There are several disadvantages of using biometric fingerprint technology with this system. Firstly, the technology does not function accurately in a significant percentage of cases. Many senior subjects or laborers are especially prone to problems with this technology as the system has difficulty reading the fingerprints. To supply all research sites in the country is not only expensive, but remains impractical and problematic as well. There are hardware and software installations required with this technology, which adds cost and time. When problems are encountered with fingerprint scanning, it slows down the entire screening process. Many potential research subjects have concerns about leaving biometric information with the research site. Clinical RSVP remains focused on early phase studies as providing fingerprint scanners to every research site across the country would be too expensive and time consuming. Clinical RSVP therefore does not have penetration to later phase studies and many subjects are known to cross between phase 1 studies and later phase studies.

While many of the above described systems can generate databases of prospective participants in clinical trials, there is no unified system to stop research subjects from enrolling in more than one clinical trial at a time or waiting the mandated thirty day period between clinical trials, exclusionary criteria that are listed in most drug and device clinical trials. Therefore, there remains the need for an improved screening system for clinical trials.

### SUMMARY OF THE INVENTION

The present invention provides for a method of screening participants for a clinical trial by obtaining a biometric sample from a prospective participant, generating a unique identifier code, populating a database with the unique identifier code and participant information and storing the database on computer readable media, and screening the participant for a clinical trial based on the unique identifier code and participant information.

The present invention provides for a method of screening participants for a clinical trial by obtaining personal information from a prospective participant, generating a unique identifier code, populating a database with the unique identifier code and participant information and storing the database on computer readable media, and screening the participant for a clinical trial based on the unique identifier code and participant information.

The present invention also provides for a database stored on computer readable media populated by unique identifier codes of prospective participants of clinical trials obtained by the above methods.

### DESCRIPTION OF THE DRAWINGS

Other advantages of the present invention are readily appreciated as the same becomes better understood by reference to the following detailed description when considered in connection with the accompanying drawings wherein:

FIG. 1 is a flow chart of the general method of the present invention;

FIG. 2 is a flow chart of steps of the method of checking participant credentials;

FIG. 3 is a flow chart of further steps of the method of checking participant credentials; and

FIG. 4 is a flow chart of further steps of the method of checking participant credentials.

### DETAILED DESCRIPTION OF THE INVENTION

The present invention generally relates to the use of biometric identification techniques, such as DNA identification, to allow for accurate screening for clinical trials in order to improve the reliability of data obtained while maintaining the confidentiality of the prospective and actual participants. The present invention is particularly suited to prevent persons from enrolling in multiple or repeated clinical trials under false identities for collecting remuneration.

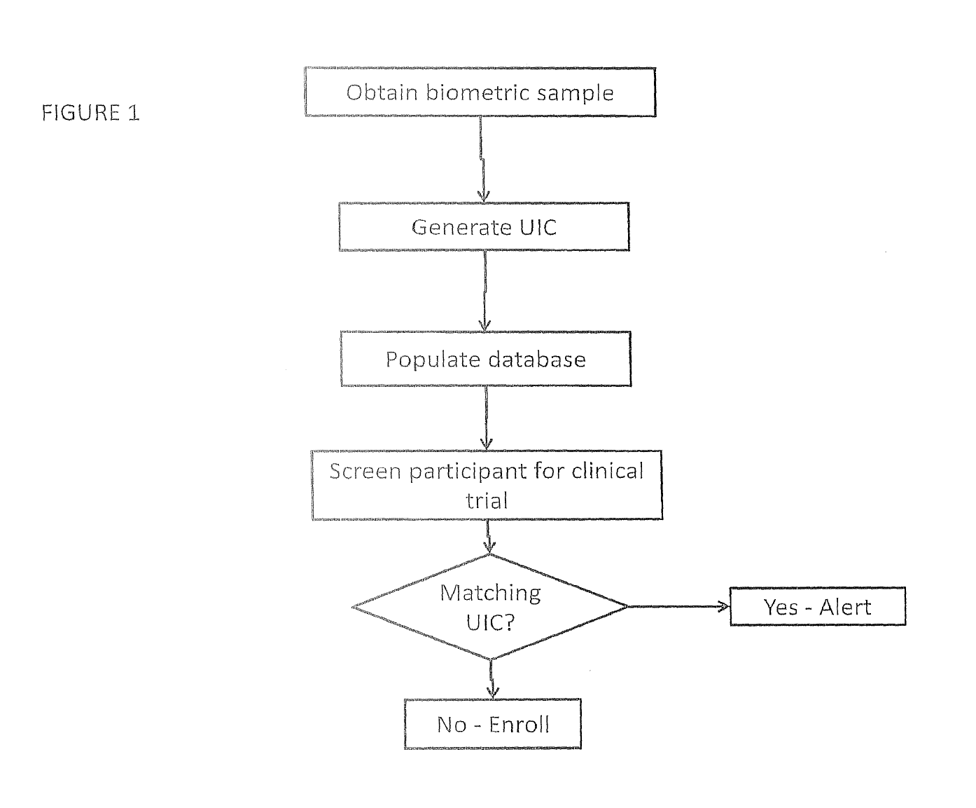

The method, generally shown in FIG. 1, can involve the steps of obtaining a biometric sample from a prospective participant, generating a unique identifier code, populating a database with the unique identifier code and participant information and storing the database on computer readable media, and screening the participant for a clinical trial based on the unique identifier code and participant information. Alternatively, a biometric sample does not need to be taken, and instead personal information is obtained from the participant in order to generate the unique identifier code. These methods have the technical effect of helping determine which prospective participants are eligible to participate in the clinical trial in order to populate the clinical trial.

When a prospective participant applies to be in a clinical trial, a biometric sample is taken from them to add to/compare with the database. Preferably, the biometric sample is a tissue sample that can be analyzed for DNA, RNA, or any other unique biological identifier. Because everyone has a unique DNA profile, this can be used to identify participants with greater accuracy than by taking their name and government assigned information. The sample can be hair or a body fluid such as saliva, urine, blood, or plasma. The sample can also be obtained by a cheek swab. The sample is tested to produce a unique identifier code (UIC) associated with the prospective clinical trial participant. The code can be based on the specific genetic code of the DNA. The biometric information obtained can generate a UIC for the research participant and be stored in the database. When the participant presents to the research facility again, the UIC is detected as an identical match within the database and the research site would have the dates of his eligibility. If the participant is not beyond a 30-day window of study completion or termination, then that participant is not eligible to participate in the study. If it is more than the needed time frame, the participant can enter the next clinical trial provided they meet all of the study specific eligibility criteria. The biometric sample can also be an iris scan, or a voice recording, from which a unique identifier code can be generated.

The unique identifier code can also, in addition to information obtained from the biometric sample or alternatively to the biometric sample, use a subset of personal demographic information, such as, but not limited to, first name, middle name, last name, date of birth, gender, and government issued identification (social security or tax ID numbers). Therefore, the present invention also provides for a method of screening participants for a clinical trial by obtaining personal information from a prospective participant, generating a unique identifier code, populating a database with the unique identifier code and participant information and storing the database on computer readable media, and screening the participant for a clinical trial based on the unique identifier code and participant information. Social security numbers and tax ID numbers can also be obtained and checked instantaneously at the screening to assure that subjects are responsible for the taxes incurred for stipend disbursements. Third party software can be used to validate government identification, and can also be used to check criminal backgrounds/sex offender status in order to prevent potentially dangerous individuals from being confined with other inpatients during a study. The unique identifier code generated protects the participants' true identities and is HIPAA and GCP compliant.

Each biometric sample that is taken from a prospective participant can be entered into the database. The database can be viewed on any type of screen (computer monitor, smart phone screen, tablet, or any other wireless device). The database can be an existing database that can be accessed by any organization or one created by the particular organization for their particular clinical trial or set of clinical trials. Access to the database can be via a remote connection (wireless, Bluetooth) or a wired connection. Fields of the database are populated with the participant's biometric identifying information (i.e. unique identifier code) along with any other relevant information about the participant, such as, but not limited to, their history of participation in other clinical trials, status of current enrollment or prospective enrollment in clinical trials, the study start and end dates of the other clinical trials, the sponsor and sponsor information for the other clinical trials, and the trial site, contact person, protocol identifier, study number, and combinations thereof. The database is secure, and while a participant can delete their personal information from the database, the database stores the unique identifier code for the screening step. The present invention also provides for the database stored on computer readable media populated by the unique identifier codes.

After the information for the prospective participant is added to the database, it can be compared with other information from the other prospective participants in the database in the screening step. If an individual is found with matching unique identifier codes to another individual, an alert can be made that the prospective participant is potentially enrolling in the trial multiple times, enrolling in multiple trials at once, or enrolling in a trial sooner than the mandatory 30 day period between clinical trials. The database can detect matching information within seconds to identify potential conflicts. If a subject is a “Verification Failure”, the research site coordinator is immediately aware and can inform the subject. If there is a conflict whereby the subject states that this information is not correct, then the research coordinator can contact higher administration for immediate exploration and resolution of the problem by contacting the prior research site. The administration can fully review the information provided by the prospective participant to determine if they should be included in the clinical trial. By catching potential multiple enrollees or unqualified enrollees, the organization can prevent repeated data and other problems from occurring during the clinical trial.

Otherwise, if no matching information is found, the participant can be entered into the clinical trial. If there is no conflict, the research coordinator can obtain a “Verification Success” certificate generated by the system and place this in the source document.

The sponsor of the clinical trial can see screening, enrollment, and other completion activity logs in real time.

The database can include a visit reminder feature to send SMS text and/or email to remind subjects of their upcoming visits to reduce out of window visits (late appointments) and subsequent protocol deviations. Every time that a reminder is sent out, this can include instructions for their upcoming visit. This can help ensure that the subject is properly prepared for their upcoming visit.

Reports of any of the information in the database can be created as desired. For example, reports of prospective participants who attempt to enroll in multiple clinical trials at once or for the same trial twice can be generated. Reports regarding attempted simultaneous enrollments are important to know in an effort to gauge the problem within the industry as well as to let the Sponsor and CRO (contract research organization) know the value of the service.

There are several advantages of the present invention. The unique identifier code is reproducible and can catch minor variations of the information in cases of different forms of identification being used to create the unique identifier code or when there is human error with data entry. The method and system can be used for all phases of studies in all types of disease entities for drug and device trials.

The invention is further described in detail by reference to the following experimental examples. These examples are provided for the purpose of illustration only, and are not intended to be limiting unless otherwise specified. Thus, the invention should in no way be construed as being limited to the following examples, but rather, should be construed to encompass any and all variations which become evident as a result of the teaching provided herein.

### EXAMPLE 1

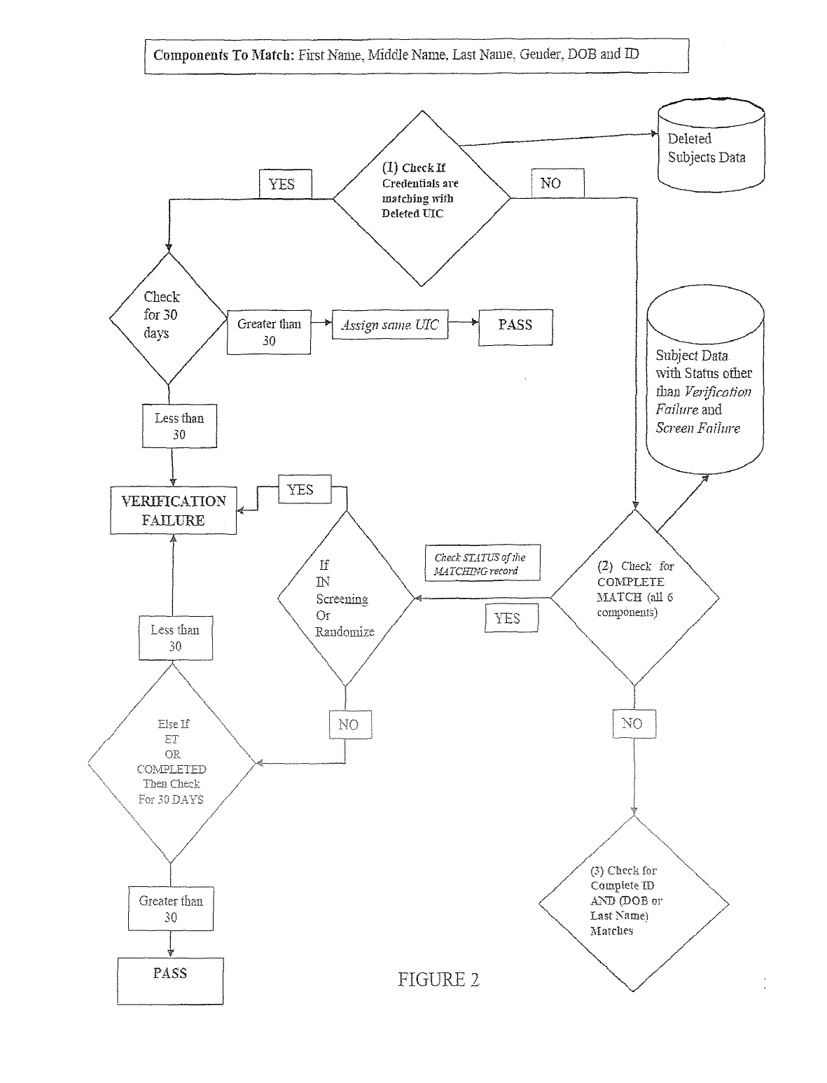

FIGS. 2-4 show more detailed steps in the method of screening participants for the clinical trials. Each of these steps can be modified as necessary for a particular trial. TABLE 1 below summarizes the various steps of inputs, outputs, and rules violated. Failure Rules and Warning Rules are also summarized below.

In the first step (1), it must be determined whether the patient credentials match deleted UIC's within the system. If there is a match, it is checked whether the data was entered 30 days or more. If 30 days have passed, the same UIC can be assigned to the participant and they can be entered in the trial. If it has been less than 30 days, there is a verification failure and the participant should not be entered in the trial.

If the patient credentials did not match deleted UIC's, a complete match is checked for at (2). If there is a complete match, and if the participant is in Screening or Randomized, there is a verification failure. Once a patient signs a study specific consent, they enter the screening period. In this period a series of tests are performed to see if they are eligible and meet the criteria to proceed with the study and receive the medication or treatment offered in the protocol. Randomization is the process of administering treatment, which can include placebo. At this point they are monitored for efficacy and any adverse events. Once a participant signs consent and is “in screening” they can no longer screen for or participate in another clinical trial until they either early terminate or complete the study and for at least 30 days thereafter. If the participant is not in Screening or Randomized, and ET or Completed is the case, a check is made for 30 days passing ET means early terminate for various reasons. This can be for adverse events or side effects, lack of efficacy, or competing medical issues, or simply if the subject withdraws their consent and no longer wishes to participate. Completed means they finished all planned visits of the study and will be eligible for any other study at least 30 days or more later. If less than 30 days have passed, there is a verification failure, but if 30 days or more have passed, the participant can be entered into the trial.

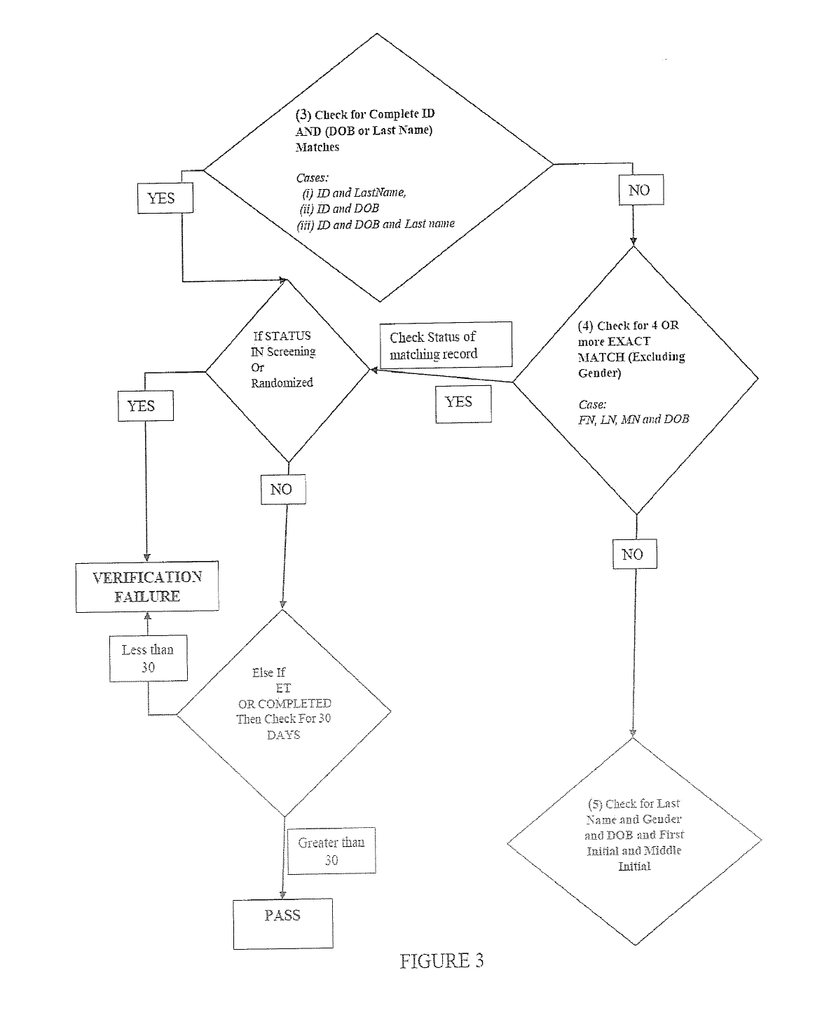

If there was not a complete match at (2), a check is made for complete ID and (Date of Birth (DOB) or Last Name) matches at (3) (see FIG. 3). There are several cases that could match: ID and Last Name, ID and DOB, or ID, DOB, and Last Name. If there is a match at (3), the status is checked for the participant being in Screening or Randomized, and if they are, there is a verification failure. If they are not, and ET or Completed is the case, a check is made for 30 days passing. If less than 30 days have passed, there is a verification failure, but if 30 days or more have passed, the participant can be entered into the trial.

If a match was not made at (3), a check is made for 4 or more Exact Matches (excluding gender), such as First Name (FN), Last Name (LN), Middle Name (MN), and DOB at (4). If a match is found, the steps are performed the same as if a match is found at (3).

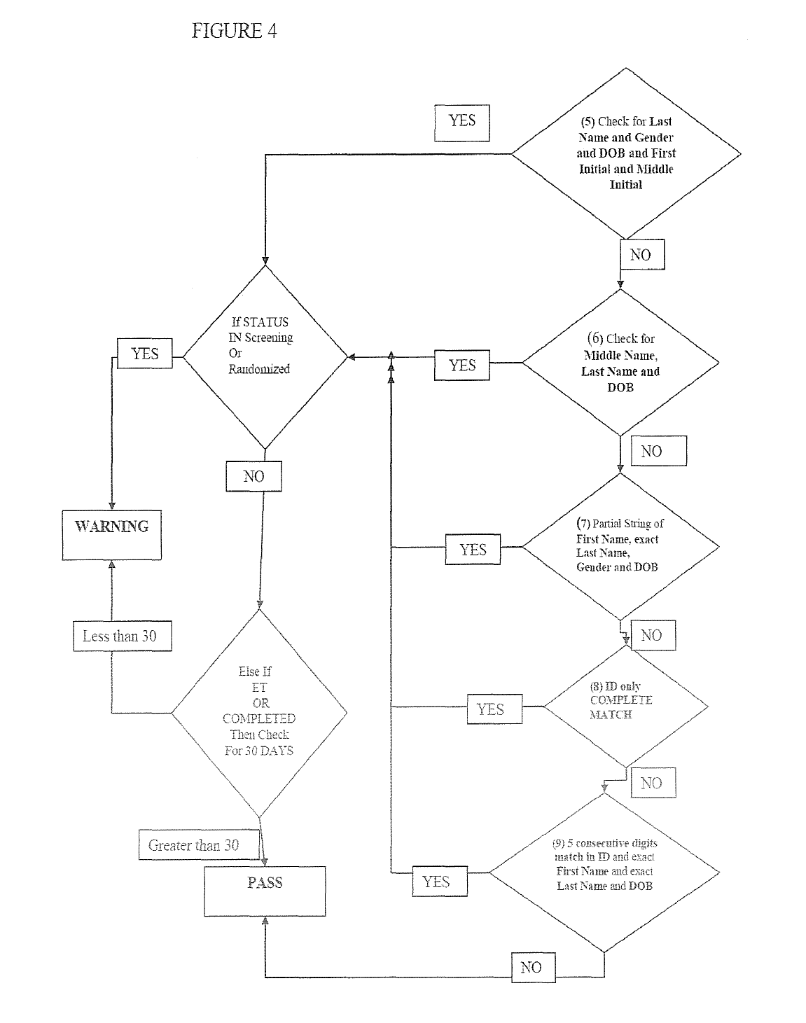

If a match is not found at (4), then a check is made for a match of Last Name, Gender, DOB, First Initial, and Middle Initial at (5) (see FIG. 4). If there is a match, the status is checked for the participant being in Screening or Randomized, and if they are, there is a Warning. A Warning means that there are many identifiers in the information that are not an exact match of the UIC. For instance, if there is a typographical error and a wrong birthdate is put in to the system, or if the name is not entered exactly then an amber colored warning banner can appear on the screen. It states that there are many portions of information that very closely resemble a subject already in the database and to please make sure there are no errors. The study coordinator or individual entering the data can make the choice if this indeed not a match or is a match and thereby resulting in a Verification Success or pass, or Verification Failure. If the participant is not in Screening or Randomized, and ET or Completed is the case, a check is made for 30 days passing. If less than 30 days have passed, there is a Warning, but if 30 days or more have passed, the participant can be entered into the trial.

If a match is not found at (5), then a check is made for a match of Middle Name, Last Name, and DOB at (6). If there is a match, the steps are performed the same as if a match is found at (5).

If there is not a match at (6), a check is made for a match of Partial String of First Name, exact Last Name, and Gender at (7). If there is a match, the steps are performed the same as if a match is found at (5).

If there is not a match at (7), a check is made for a match of ID only being a complete match at (8). If there is a match, the steps are performed the same as if a match is found at (5).

If there is not a match at (8), a check is made for a match of 5 consecutive digits of the ID, exact First Name, exact Last Name, and DOB at (9). If there is a match, the steps are performed the same as if a match is found at (5). If there is not a match, then the participant can be entered into the trial.

TABLE 1

| Sr. No | Input | Output | Rule Violated |
|---|---|---|---|
| 1 | Complete Id AND DOB | Failure | #3 |
| 2 | Complete Id AND Last Name | Failure | #3 |
| 3 | Complete Id AND First Name | Warning | Not tracked by any |
| | | | Rule |
| 4 | Complete Id AND Middle Name | Warning | Not tracked by any |
| | | | Rule |
| 5 | Complete Id AND Gender | Warning | Not tracked by any |
| | | | Rule |
| 6 | Complete Id AND Initials | Warning | Not tracked by any |
| | | | Rule |
| 7 | First Name, Last Name, Middle Name | Failure | #4 |
| | and DOB | | |
| 8 | First letter of First Name, First Letter | Warning | #5 |
| | of Middle Name, complete Last Name, | | |
| | Gender AND DOB | | |
| 9 | Complete Middle Name, Complete | Warning | #6 |
| | Last Name AND DOB | | |
| 10 | First 3 letters of First Name, complete | Warning | #7 |
| | Last Name, Gender AND DOB | | |
| 11 | Only ID Number completely Matches | Warning | #8 |
| 12 | 5 consecutive digits in ID, complete | Warning | #9 |
| | First Name, Complete Last Name | | |
| | AND DOB | | |
| 13 | 5 consecutive digits in ID AND First | Pass | |
| | Initial | | |
| 14 | 5 consecutive digits in ID AND | Pass | |
| | Complete First Name | | |
| 15 | 5 consecutive digits in ID AND | Pass | |
| | Complete Last Name | | |
| 16 | 5 consecutive digits in ID AND | Pass | |
| | Complete Middle Name | | |
| 17 | 5 consecutive digits in ID AND Gender | Pass | |
| 18 | 5 consecutive digits in ID AND DOB | Pass | |
| 19 | First Initial, Complete Middle, | Pass | |
| | Complete Last AND Gender | | |
| 20 | All Credentials not matching | Pass | |
| 21 | First Initial, middle initial, last initial | Pass | |
| | and DOB | | |
| 22 | First Initial, middle initial, last initial | Pass | |
| | and gender | | |

Failure Rules:

Rule 1: If UIC matches with a deleted Subject, Then check if the 30 days have been past its deletion, If yes then PASS, otherwise FAILURE

Rule 2: All Credentials Complete Match

Rule 3: [Complete ID and DOB] OR [Complete ID and Last Name]

Rule 4: 4 or More Exact Match excluding Gender.

Warning Rules:

Rule 5: First Initial and Middle Initial and exact Last name and Gender and DOB

Rule 6: exact Middle Name and exact Last Name and DOB

Rule 7: Partial string matches in First Name and exact Last Name and Gender and DOB

Rule 8: Complete ID Only

Rule 9: 5 consecutive digits in ID and exact First Name and exact Last Name and DOB

### EXAMPLE 2

The following is an example of an algorithm used to encrypt and decrypt data.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A method of screening participants for a clinical trial, including the steps of:
obtaining a biometric sample from a prospective participant;
generating a unique identifier code;
populating a database with the unique identifier code and participant information and storing the database on computer readable media; and
screening the participant for the clinical trial based on the unique identifier code and participant information.

2. The method of claim 1, wherein the biometric sample is a sample chosen from the group consisting of hair, saliva, urine, blood, or plasma.

3. The method of claim 1, wherein the biometric sample is analyzed for a component chosen from the group consisting of DNA and RNA.

4. The method of claim 1, wherein the biometric sample is chosen from the group consisting of an iris scan and a voice recording.

5. The method of claim 1, wherein the participant information is chosen from the group consisting of history of participation in other clinical trials, status of current enrollment or prospective enrollment in clinical trials, the study start and end dates of the other clinical trials, the sponsor and sponsor information for the other clinical trials, and the trial site, contact person, protocol identifier, study number, and combinations thereof.

6. The method of claim 1, wherein said screening step further includes the step of making an alert if the participant is found to have matching unique identifier codes to a second participant.

7. The method of claim 1, wherein said screening step further includes the step of entering the participant into the clinical trial if no matching unique identifier code or participant information is found.

8. The method of claim 7, wherein the database sends reminders to participants regarding upcoming visits for the clinical trial.

9. The method of claim 1, further including the step of generating reports from information in the database.

10. A method of screening participants for a clinical trial, including the steps of:
obtaining personal information from a prospective participant;
generating a unique identifier code;
populating a database with the unique identifier code and participant information and storing the database on computer readable media; and
screening the participant for a clinical trial based on the unique identifier code and participant information.

11. The method of claim 10, wherein the personal information is chosen from the group consisting of first name, middle name, last name, date of birth, gender, and government issued identification.

12. The method of claim 10, further including, after said obtaining step, the step of obtaining government issued identification and assuring that the participant is responsible for taxes incurred for stipend disbursements.

13. The method of claim 10, further including, after said obtaining step, the step of obtaining and validating government issued identification for criminal backgrounds and sex offender status.

14. The method of claim 10, wherein the participant information is chosen from the group consisting of history of participation in other clinical trials, status of current enrollment or prospective enrollment in clinical trials, the study start and end dates of the other clinical trials, the sponsor and sponsor information for the other clinical trials, and the trial site, contact person, protocol identifier, study number, and combinations thereof.

15. The method of claim 10, wherein said screening step further includes the step of making an alert if the participant is found to have matching unique identifier codes to a second participant.

16. The method of claim 10, wherein said screening step further includes the step of entering the participant into the clinical trial if no matching unique identifier code or participant information is found.

17. The method of claim 16, wherein the database sends reminders to participants regarding upcoming visits for the clinical trial.

18. The method of claim 10, further including the step of generating reports from information in the database.

19. A database stored on computer readable media populated by unique identifier codes of prospective participants of clinical trials obtained by the method of claim 1.

20. A database stored on computer readable media populated by unique identifier codes of prospective participants of clinical trials obtained by the method of claim 10.
